(19) United States
(12) Patent Application Publication
(10) Pub. No.: US 2007/0143118 A1
(43) Pub. Date: Jun. 21, 2007

(54) Apparatus and method for lossless audio signal compression/decompression through entropy coding

(76) Inventors: Hsin-Hao Chen, Kaohsiung City (TW); Guo-Zua Wu, Taichung (TW); Jau-Jiu Ju, Hsinchu Hsien (TW); Der-Ray Huang, Kuang-Ming Hsin Tsun (TW)

Correspondence Address: J.C. Patents, Inc., Suite 250, 4 Venture, Irvine, CA, 92618, US

(21) Appl. No.: 11/439,616

(22) Filed: May 23, 2006

(30) Foreign Application Priority Data
Dec. 15, 2005 (TW) 94144420

(51) Int. Cl. G10L 21/00; H04K 1/00

(52) U.S. Cl. 704/500; 380/269

(57) ABSTRACT

An apparatus and method for lossless audio compression/decompression through entropy coding are provided. The apparatus comprises a buffer, a time-axis predictor, and a bit-allocation entropy coder/decoder, wherein the time-axis predictor is capable of subtracting the predicted value of a current input signal value from its original value, thereby generating a predicted error signal. The predicted error signal is then input into the bit-allocation entropy decoder in accordance with a coding guideline, and in turn is coded into data blocks with different lengths. Further, the data blocks after entropy coding comprise a 32-bit header and the real data following the header, wherein the real data is substantially a discrepancy between the prediction error of the data and the minimum value of each data block.

### CROSS-REFERENCE TO RELATED APPLICATION

This application claims the priority benefit of Taiwan application serial no. 94144420, filed on Dec. 15, 2005. All disclosure of the Taiwan application is incorporated herein by reference.

### BACKGROUND OF THE INVENTION

1. Field of Invention

The present invention relates to an apparatus and method for audio signal compression/decompression, and more particularly, to an apparatus and method for lossless audio signal compression/decompression through entropy coding.

2. Related Art

The transmission of high-quality audio-visual information becomes an inevitable trend with the development of broadband transmission environments, such as broadband networks and wireless communication. The capacity for transmitting audio-visual information is the major difference between the Third Generation Mobile Communication Systems (3G) and the current GSM. With the advance of communication technology, the transmission of high-quality and even lossless audio signal has become one possible trend. A lossless audio signal mainly offers a user a complete editing room and audio signals with different bit rates can be transmitted according to different applications. As to music and songs, the user usually prefers their higher quality. The lossless audio signal offers the user the complete editing room and is necessitated from the point of enjoying the music.

Furthermore, the International Standardization Organization ISO/IEC MPEC responsible for enacting the international audio-visual compression specification began discussing whether a new Audio Lossless Coding (ALS) needs to be enacted or not in the 59^{th} meeting. During the meeting, the topic was discussed hotly, and sufficient evidence shows that a new specification is industrially required, and the technique has been developed to the extent capable of being normalized. At present, the enactment of the new specification proceeds to the final stage and the overall enactment of the specification is estimated to reach a conclusion by the end of 2005. At the same time, MPEG begins to enact the specification of Speech Lossless Coding. On the other hand, there are a number of non-internationally standardized lossless audio compression systems, such as, Monkey, free lossless audio coder/decoder (FLAC), and Microsoft window medium audio (WMA). Most lossless audio compression systems include two parts: a time-domain prediction and entropy coding of prediction errors. The time-domain prediction includes two ways: one is a forward prediction and the other is a backward prediction. So-called forward prediction means that the predicted value of the current data is derived from the previous data value through a prediction filter, which has the most significant difference with the backward prediction in that the coefficient of the forward prediction filter is selected in advance, such that this coefficient must be stored in compression data. Thus, a decoding terminal is able to completely and correctly decode the previously coded data. On the other hand, as for the backward prediction, the coefficient of the prediction filter is timely updated through an adaptive algorithm during the predicting period, such that it is unnecessary to generate redundant information to be stored in the coded data. The data is ensured to be recovered only if the decoding terminal employs the same prediction filter, capable of performing a coefficient updated algorithm, as the coding terminal.

Herein, so-called entropy coding is a wide term and mainly directed to carry out further compression through a coding method exploiting a prediction error with the characteristic of a smaller value. The typical methods include a variable-length coding (VLC), a Huffman coding, an arithmetic coding, and so on.

The digitalization of an audio is stored in a way of sampling the successive analog signals with a fixed-data resolution. However, the size of the original audio signal data is relatively large if no process is carried out. Since the time-domain correlation between adjacent sampling values is quite high, an appropriately predicted coding is carried out to these data by utilizing such a correlation in order to reduce the data size. Some compression techniques cause data loss, which are called lossy compression techniques, meaning that the data recovered by the decoding terminal is different from the original data. But such a difference cannot be distinguished by human ears, and one advantage is that the data size is greatly reduced. However, a lossless audio compression, in contrast to the lossy compression, is capable of recovering the audio signal data to be the same as that before compression.

Several conventional methods for the lossless audio compression are listed below. U.S. Pat. No. 6,675,148 also discloses a lossless audio compression system, wherein an input audio signal is divided into audio frames; then, the data of the audio frames is predicted, and also the coefficient of the predictor is quantified and stored as a part of the data; and finally, the predictive coded audio frames can be further divided into much smaller sub-blocks for entropy coding.

Alternatively, U.S. Pat. No. 5,884,269 discloses a lossless compression/decompression apparatus for the digital audio. FIG. 1 is a coding block diagram of the lossless compression/decompression apparatus for the digital audio. As shown in FIG. 1, firstly, an uncompressed audio is input. Then, the uncompressed audio is processed by a prediction filter, also referred to as a predictor, to generate a prediction error signal. Next, through an optimal table selector, the prediction error signal selects a set of optimal tables from both a Huffman table dictionary comprising a pre-selected table and a compact Huffman weight table. The entropy coding is carried out through the set of optimal tables, that is, a Huffman coding and a frame coding are carried out. At this moment, as the entropy coding is able to direct to the Huffman table selected by the error signals for each audio frame so it can most effectively carry out the coding of the error signals for each audio frame, so as generate coded data using as few bits as possible (shortest data is a theoretically optimal case), thereby enhancing the compression ratio. Finally, the entropy coded audio is output and stored.

With reference to FIG. 2, it is a decoding block diagram of a lossless compression/decompression apparatus for digital audio signal. Substantially, the sequence of the decoding in FIG. 2 is a reverse direction as shown in FIG. 1. That is, an entropy coded audio signal is input into a frame decoding region. The frame decoding region can read information of the employed Huffman table from the header of the entropy coded audio signal and select a corresponding Huffman table from the Huffman table dictionary by using the information. As such, the entropy coded audio signal proceeds to the next step, i.e. Huffman decoding, to recover the prediction error signal. Then, the prediction error signal is input to a reverse predictor, such that the corresponding predicted value is added to the prediction error signal, thereby recovering the original value of the audio signal, i.e., the original audio signal before compression.

However, the aforementioned conventional arts, either Huffman table coding or arithmetic coding, requires a large amount of computations, and thus is not suitable for a real-time compression. Therefore, it is necessary to provide an entropy coding method with a small amount of computations, suitable for various time-domain predictions and an apparatus thereof.

### SUMMARY OF THE INVENTION

One main object of the present invention is to provide an audio entropy coding apparatus suitable for various time-domain predictions with high efficiency, high compression ratio, and fewer computations, and a method thereof. The apparatus comprises a buffer, a time-axis predictor, and a bit-allocation entropy coder/decoder. The time-axis predictor is capable of subtracting the current input signal value from its predicted value, thereby generating a prediction error signal corresponding to the compressed input signal. Then, the prediction error signal is input into the bit-allocation entropy coder in accordance with a code guideline of the present invention to be coded. Further, each block data packet structure after the entropy coding in the present invention comprises a 32-bit header and the real data following the header, but the data is substantially the discrepancy between the original prediction error of the data and the minimum value of each of the blocks. Through the foregoing method, the conventional complicated calculation is reduced, i.e., high efficiency entropy coded audio can be obtained. The time-axis predictor comprises a recursive least square (RLS) and a least mean square (LMS) predictor.

One further object of the present invention is to provide a coding guideline of an audio entropy coding apparatus and a method suitable for various time-domain predictions. The coding guideline is used to analyze the prediction error signal and to divide it into different blocks according to the required data precision. In fact, the division of the blocks is jointly decided by four essential conditions. When any one of the following four conditions is satisfied, the coder generates a new coding block according to the coding guideline, and writes the block header and the data. The four conditions are that (a) the data precision for coding the error signal is higher than that for the previous error signal, and the required additional capacity offered by the whole block is greater than 32-bits in size due to the coding of the signal; (b) 50 items of data already exist in the current block, and the number of bits required for coding the current data point is greater than the data size precision required by each of the subsequent fifty points; (c) the discrepancy between the current predicted error value and the predicted error value of the previous time point is greater than a predetermined value, and the required additional capacity offered by the whole block is greater than 32-bits in size due to the coding of the signal; or (d) 4096 points already exist in the current block.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a coding block diagram of a conventional lossless compression/decompression apparatus for a digital audio signal;

FIG. 2 is a decoding block diagram of a conventional lossless compression/decompression apparatus for a digital audio signal;

FIG. 3 is an audio entropy coding apparatus suitable for various time-domain predictions according to one preferred embodiment of the present invention;

FIG. 4 is a diagram showing the magnitude of a prediction error signal value;

FIG. 5 is a schematic view of blocks of one entropy coding according to one preferred embodiment of the present invention; and

FIG. 6 shows an audio entropy decoding apparatus suitable for various time-domain predictions according to one preferred embodiment of the present invention.

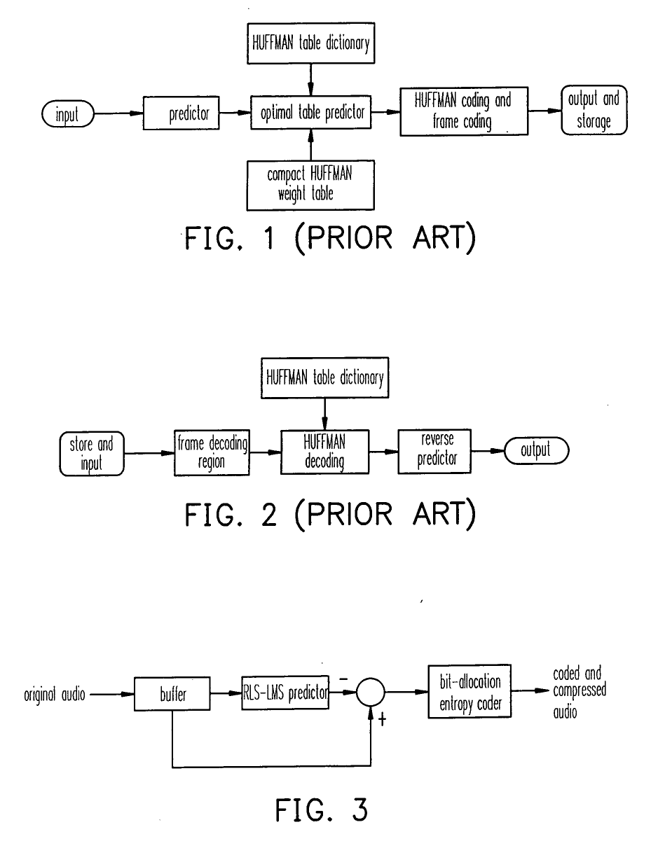

### DETAILED DESCRIPTION OF THE INVENTION

With reference to FIG. 3, it is an audio entropy coding apparatus suitable for various time-domain predictions according to one preferred embodiment of the present invention. The audio entropy coding apparatus comprises a buffer, a time-axis predictor, and a bit-allocation entropy decoder. The buffer is used to divide an input uncompressed original audio into multiple audio frames, and the audio frame is one-dimensional data of an audio value containing a fixed number of audio points arranged in sequence. The time-axis predictor is used to subtract an audio value input into the audio frame at a time point from the predicted value of said audio signal, thereby generating a prediction error signal corresponding to the compressed audio signal, which is substantially a value or also referred as a prediction error signal value. The initial prediction value at the beginning of the prediction operation is set to be zero, i.e., an uncompressed original audio signal is first input into the time-axis predictor and the value of the audio signal is stored in the time-axis predictor as the prediction basis for the subsequent input audio signal. Then, the prediction error signal is further input into the bit-allocation entropy coder/decoder in accordance with the coding guideline of the present invention, and then coded and divided into data blocks with variable lengths, wherein a data block comprises a header and a prediction error signal of each audio point in the block. The time-axis predictor comprises two parts: an RLS predictor and an LMS predictor.

An audio entropy coding method suitable for various time-domain predictions in the present invention comprises the following steps. Firstly, an uncompressed original audio signal is input into a buffer to be divided into one-dimensional data with fixed lengths, being referred as audio frames. Then, each of the audio frames passes through a time-domain RLS-LMS predictor, and since the RLS predictor is placed on the first part of the whole predictor due to its much higher convergence rate, (i.e., the speed of being converged to nearly zero of the prediction error), the uncompressed audio signal first passes through the RLS predictor, and then the generated predicted error is sent to the LMS predictor to further undergo predicting coding, thereby generating a predicted error value. Finally, the predicted error value is input into a bit-allocation entropy coder/decoder, and is analyzed and coded into the coding audio data in different blocks according to the coding guideline of the present invention and required data precision.

Since the overall predicting coding is adaptively predicted and calculated by the predictor, the coefficient of the predictor need not to be transferred to the decoder, thereby saving some data space. When decoding, the original data can be recovered unchangeably as long as the decoder also utilizes the same filter algorithm as that of the encoder.

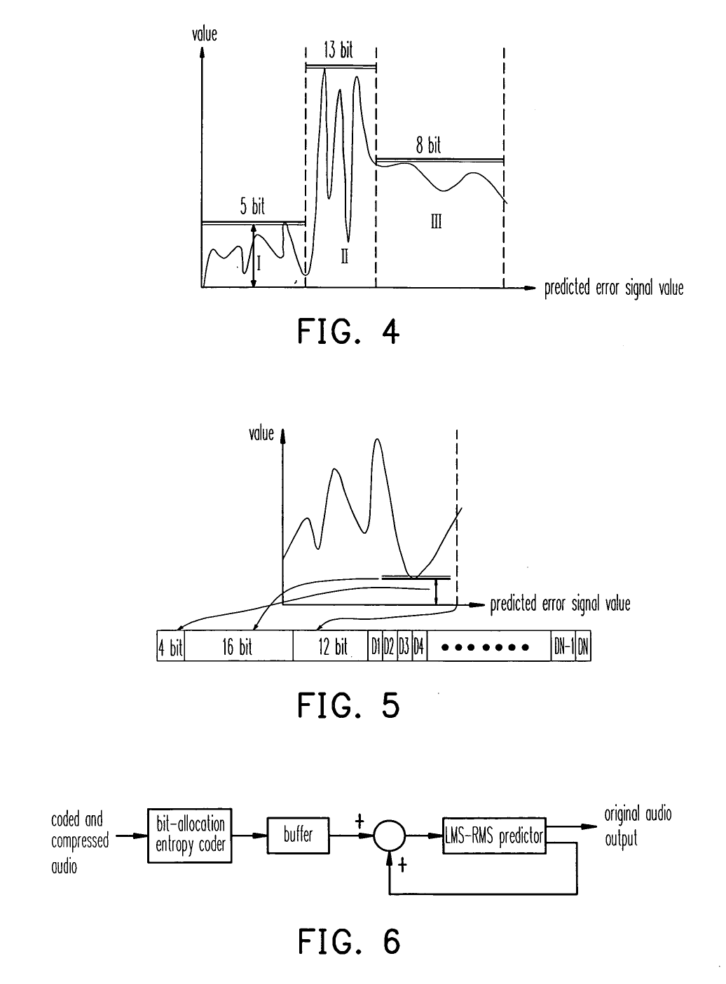

Generally, if the predictor is capable of properly carrying out predicting coding to the audio signal, the predicted error value will be far smaller than the original signal value in order to achieve the purpose of data compression. In typical lossless audio compression, besides the predicting coder, an entropy compression coder is subsequently employed to further compress the data by utilizing (exploiting) its characteristic that the predicted error value is smaller than the original audio value. The present invention provides an entropy coding method across audio frames as shown in FIG. 4. In the method, according to several guidelines of the present invention, the predicted error signal is divided into quite a few sub-blocks. FIG. 4 shows a section of predicted error signal values, which fluctuate dramatically, wherein some parts occupy about 5 bits while others require more than ten bits to represent an error value. If 13-bits are used to represent data in the whole block, the data compression space is generally still quite sufficient, although as compared to the original precision of 16-bits, the data size has been reduced. Therefore, the present invention provides a method for analyzing and then dividing the predicted error signal into different blocks according to the required data precision, wherein each item of data in the block represents the information with the same precision, and the stored information is not the original data value but the discrepancy between the value of each time point and the minimum value of the block. Additionally, a 32-bit data space should be reserved for data arrangement in each of the record blocks.

With reference to FIG. 5, it is a schematic view of blocks of one entropy coding, wherein a header with a fixed length of 32-bits is in front of the real data. The header comprises three field messages. First, 4-bits are used to represent the data precision of all data in the block; then, 16-bits are used to represent the foregoing minimum value, wherein it should be noted that, the minimum value is not the original value of the audio signal but the minimum predicted error value of the block; and finally, 12-bits are used to represent the points of the block. Therefore, at most 4096 items of data can be stored in each block. The real data D1, D2, D3 . . . DN-1, DN is closely following the header. As described above, not the original value but the discrepancy between each of the data points and the minimum value of the block is stored.

The aforementioned division and coding of the blocks is jointly decided by four essential conditions. When any one of the following four conditions is satisfied, the coder generates a new coding block and writes the block header and the data. The four conditions are that (a) the data precision for coding the predicted error signal is higher than that for the previous predicted error signal, and the required additional data offered by the whole block is greater than 32-bits in size due to the coding of the signal; (b) 50 items of data already exist in the current block, and the number of bits required for coding the current data point is greater than the data size precision required by each of the subsequent fifty points; (c) the discrepancy between the current predicted error value and the previous predicted error value is greater than a predetermined value, and the required additional data offered by the whole block is greater than 32-bits in size due to the coding of the signal; or (d) 4096 points already exist in the current block.

With reference to Table 1, it compares the percentages of the calculation reduction when three different kinds of songs are compressed through four different audio compression formats: that of the present invention, FLAC, Wavpack, and WMA under substantially the same compression rate, such as, 1.508 and 1.405.

TABLE 1

| | Present | | | |
|---|---|---|---|---|
| | Invention | FLAC | Wavpack | WMA |
| rock and roll | 1.508 | 1.405 | 1.482 | 1.480 |
| in English | | | | |
| lyric music | 1.575 | 1.450 | 1.534 | 1.547 |
| rock and roll | 1.500 | 1.417 | 1.497 | 1.491 |
| in Chinese | | | | |
| percentages | | 5% | 7% | 10% |
| of calculation | | | | |
| reduction | | | | |

Table 1 obviously shows that, as compared to the other three different kinds of audio compression formats, the audio compression of the present invention needs far fewer calculations.

With reference to FIG. 6, it shows an audio entropy compression decoding apparatus suitable for various time-domain predictions according to one preferred embodiment of the present invention. The decoding apparatus comprises a bit-allocation entropy decoder, a buffer, and a reverse predicting decoder having the LMS-RMS. The decoding of the decoding apparatus comprises the following steps. Firstly, the input signal to be decoded, i.e., the coded and compressed audio, is transferred to the bit-allocation entropy decoder, in order to be recovered to an audio frame of the compressed audio data. Then, the audio frame is input into the buffer in order to be recovered to the data point of each compressed audio with a predicted error value. Eventually, the data point of each compressed audio is transferred to a reverse predicting decoder to undergo predicting decoding, such that uncompressed original audio data is obtained.

In view of the above, as compared to the conventional arts, an audio entropy coding apparatus and a method thereof provided by the present invention have the following advantages:

1. Since the computations of audio coding/decoding required by the present invention is significantly reduced, the present invention is suitable for a real time compression, and the time needed for audio coding/decoding is further reduced.

2. Since the audio entropy coding apparatus suitable for various time-domain predictions provided in the present invention requires the Huffman table dictionary and the compact Huffman weight table as in the conventional arts, the audio compression/decompression coding apparatus of the present invention is simpler than the conventional arts. Therefore, the manufacturing cost is significantly reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An audio signal coding compression apparatus, comprising:
a buffer, dividing an input uncompressed audio signal into multiple audio frames, each of which is an one-dimensional audio value data containing a fixed number of audio points arranged in a timing sequence to correspond to the input uncompressed audio signal;
a time-axis predicting coder, subtracting the audio value of each audio point of each audio frame from the predicted value of the audio value, thereby generating predicted error signals of the audio values; and
an entropy coder, coding and dividing the predicted error signals into a plurality of readable data blocks with variable lengths according to a coding guideline.

2. The audio signal coding compression apparatus as claimed in claim 1, wherein the time-axis predicting coder comprises two parts: an RLS predictor and an LMS predictor, wherein the audio frames are firstly input into the RLS predictor and then the prediction error signals from RLS prediction are input into the LMS predictor.

3. The audio signal coding compression apparatus as claimed in claim 1, wherein the buffer is a segment of memory with a sufficient length to store the data of the whole audio signal.

4. The audio signal coding compression apparatus as claimed in claim 1, wherein the coding guideline depends on any one of the following four conditions being satisfied, wherein the four conditions are (a) the data precision for coding the current predicted error signal is higher than that for the previous predicted error signal, and the required additional data offered by the whole block is greater than 32-bits in size due to the coding of the signal; (b) 50 items of data already exist in the current block, and the number of bits required for coding the current data point is greater than the data size precision required by each of the subsequent fifty points; (c) the discrepancy between the current predicted error signal and the predicted error signal of the previous time point is greater than a predetermined value, and the required additional data offered by the whole block is greater than 32-bits in size due to the coding of the signal; or (d) 4096 points already exist in the current block.

5. The audio signal coding compression apparatus as claimed in claim 1, wherein the data block comprises a header and a predicted error signal of each audio point in the block.

6. An audio signal coding compression method, comprising:
inputting an uncompressed audio signal into a buffer to be divided into multiple audio frames, wherein each of the audio frames is an one-dimensional audio value data containing a fixed number of audio points arranged in a timing sequence to correspond to the input uncompressed audio signal;
inputting each of the audio frames into a time-axis predicting coder in order to subtract the audio value of each audio point of each audio frame from the predicted value of the audio value, thereby generating predicted error signals of the audio values; and
inputting the predicted error signal into an entropy coder for coding and dividing the predicted error signals into a plurality of readable data blocks with variable lengths according to a coding guideline.

7. The audio signal coding compression method as claimed in claim 6, wherein in the step of inputting each of the audio frames into a time-domain predicting coder, the uncompressed audio signal firstly passes through an RLS predictor of the time-axis predicting coder, and then the generated predicted error is input into an LMS predictor of the time-axis predicting coder to further undergo the predicting coding, thereby generating the predicted error signal.

8. The audio signal coding compression method as claimed in claim 6, wherein the readable data blocks with variable lengths comprises a header of the data block and data following the header.

9. The audio coding compression method as claimed in claim 6, wherein in the step of coding and dividing the predicted error signals into a plurality of readable data blocks with variable lengths through the entropy compressed coder according to a coding guideline, the coding guideline depends on any one of the following four conditions being satisfied, and the four conditions are (a) the data precision for the current predicted error signal is higher than that for the previous predicted error signal, and the required additional data offered by the whole block is greater than 32-bits in size due to the coding of the signal; (b) 50 items of data already exist in the current block, and the number of bits required for coding the current data point is greater than the data size precision required by each of the subsequent fifty points; (c) the discrepancy between the current predicted error signal and the predicted error signal of the previous time point is greater than a predetermined fixed value, and the required additional data offered by the whole block is greater than 32-bits in size due to the coding of the signal; or (d) 4096 points already exist in the current block.

10. An audio signal coding decompression apparatus, comprising:
an entropy decoder, recovering a data block of a coded compression audio to predicted error signals arranged in a timing sequence according to a coding guideline;
a buffer, recovering the input predicted error signals arranged in the timing sequence to multiple audio frames, wherein each audio frame are prediction error signals containing a fixed number of audio points arranged in the timing sequence; and
a time-axis predicting decoder for adding a predicted signal of each of the fixed number of audio points to its corresponding prediction error, thus obtaining the original audio signal.

11. The audio signal coding decompression apparatus as claimed in claim 10, wherein the time-axis predicted coder comprises two parts: an LMS predictor and an RLS predictor, wherein the predicted error signal of each of the fixed number of audio points is first input into the LMS predictor and then input into the RLS predictor, thereby completing the predicting decoding.

12. The audio signal coding decompression apparatus as claimed in claim 10, wherein the coding guideline is any one of the following four conditions being satisfied, and the four conditions are (a) the data precision for coding the current predicted error signal is higher than that for the previous predicted error signal, and the required additional data offered by the whole block is greater than 32-bits in size due to the coding of the signal; (b) 50 items of data already exist in the current block, and the number of bits required for coding the current data point is greater than the data size precision required by each of the subsequent fifty points; (c) the discrepancy between the current predicted error signal and the predicted error signal of the previous time point is greater than a predermined value, and the required additional data offered by the whole block is greater than 32-bits in size due to the coding of the signal; or (d) 4096 points already exist in the current block.

13. The audio signal coding decompression apparatus as claimed in claim 10, wherein the buffer is a segment of memory with a sufficient length to store the predicted error signals of the fixed number of audio points arranged in the timing sequence.

14. The audio signal coding decompression apparatus as claimed in claim 10, wherein the data block of the coded compressed audio comprises a header and the predicted error signal of each audio point following the header.
